(19) United States
(12) Patent Application Publication
(10) Pub. No.: US 2016/0094080 A1
(43) Pub. Date: Mar. 31, 2016

(54) CHARGING SYSTEM AND CHARGING METHOD THEREOF AND BATTERY PACK

(71) Applicant: CHERVON INTELLECTUAL PROPERTY LIMITED, Road Town (VG)

(72) Inventor: Aixiang Dong, Nanjing (CN)

(21) Appl. No.: 14/863,028

(22) Filed: Sep. 23, 2015

(30) Foreign Application Priority Data
Sep. 29, 2014 (CN) 201410512459.X
Sep. 29, 2014 (CN) 201410513244.X
Sep. 29, 2014 (CN) 201410514023.4
Sep. 29, 2014 (CN) 201410514417.X

(51) Int. Cl. H02J 7/02; H01M 10/44; H01M 10/46; H02J 7/04; H02J 7/00

(52) U.S. Cl. CPC H02J 7/025; H02J 7/04; H02J 7/0042; H01M 10/46; H01M 10/441

(57) ABSTRACT

A charging system includes a wireless power transmitter configured to transmit electromagnetic energy, a wireless power receiver, a wired power receiver, a signal detection means configured to detect whether power is supplied from a wireless power supply and/or from an external, wired power supply, a controller configured to manage power channels in accordance with states of wired and/or wireless power supply detected by the signal detection means, and a charging circuit configured to receive power energy from the wired or wireless power supply for charging a battery.

### CLAIM OF PRIORITY

This application claims priority to Chinese Application No. 201410512459.X, filed on Sep. 29, 2014, Chinese Application No. 201410513244.X, filed on Sep. 29, 2014, Chinese Application No. 201410514023.4, filed on Sep. 29, 2014, and Chinese Application 201410514417.X, filed on Sep. 29, 2014, the disclosure of which are hereby incorporated by reference.

### BACKGROUND OF THE INVENTION

1. Field of the Invention

The present disclosure generally relates to the field of battery charging and, more particularly, to a charging system and method which can charge a battery in various manners.

2. Description of the Related Art

An electrical tool powered by a battery pack is generally charged by a charger through a wired interface or a power connector. Because of the limited power endurance of the battery pack, it is necessary to replace the battery pack frequently or charge it. However, in many instances, it is impossible to charge the battery pack due to the lack of a power interface in an environment. Thus, it cannot always be ensured that electrical tools being used in some special environments are provided with power for a long period of time.

It is also seen that various battery packs often need different charging devices due to the characteristics of the battery packs being different, such as the chemical material in battery elements, the nominal voltage of battery, and so on. It is inconvenient for a user to purchase different charging devices for different battery packs and to carry these devices. Moreover, if the different charging devices do not have corresponding identification or protecting system, wrong operations, such as charging a battery pack with an improper charging device, will damage the battery pack resulting in unnecessary cost for the user.

The statements in this section merely provide background information related to the present disclosure and may not constitute prior art.

### BRIEF DESCRIPTION OF THE INVENTION

The objective of the present disclosure is to provide a charging system and method which can conveniently charge a rechargeable battery in various manners.

The present disclosure provides a charging system to solve the above problems, comprising:

a wireless power transmitter configured to transmit electromagnetic energy;

a wireless power receiver comprising a receiving coil and a receiving circuit, wherein the receiving coil is configured to receive the electromagnetic energy wirelessly from the wireless power transmitter, and the receiving circuit is configured to rectify and detect a receiving power;

a wired power receiver comprising a connector for receiving power energy from an external, wired power supply;

a signal detection means configured to detect the states of the wireless power transmitter and/or the external, wired power supply;

a controller configured to manage power channels in accordance with the states of the wireless power transmitter and/or the external, wired power supply as detected by signal detection means; and

a charging circuit configured to receive power energy from one of the wireless power receiver and the wired, power receiver and to charge a rechargeable battery.

Preferably, the wireless power transmitter comprises a power supply, a transmitting circuit and a transmitting coil which are electrically coupled to each other.

Preferably, power energy and data signal are transmitted between the transmitting coil of the wireless power transmitter and the receiving coil of the wireless power receiver.

Preferably, the receiving circuit is electrically coupled between the receiving coil and the charging circuit, and the receiving circuit comprises a resonant circuit and a rectifying circuit.

Preferably, the charging system further comprises an adapter for providing power energy through wires that is electrically coupled to the connector of the wired power receiver.

Preferably, the charging circuit comprises a charging detection circuit for detecting voltage states of the rechargeable battery and providing the voltage states to the controller.

Preferably, the controller comprises a battery monitoring module, and the controller is configured to obtain battery parameters from the charging detection circuit by using the battery monitoring module and to provide a charging control signal on the basis of the battery parameters to the wireless power transmitter through the wireless power receiver, and the wireless power transmitter comprises a power supply controller configured to automatically regulate an operation frequency and an output power of the transmitting coil in accordance with the charging control signal.

On another aspect, there is provided a charging method for charging a battery, comprising:

coupling a wireless power transmitter and/or an external, wired power supply to a wireless power receiver or a wired power receiver, respectively;

detecting states of power channels by a signal detection means;

determining whether the power channels that were coupled to are valid or not, and determining a number of the valid channels by a controller;

wherein, when only one power channel is valid, the valid channel is used for supplying electric energy and, when more than one power channel is valid, a first one of the power channels having been coupled to in time is selected and configured to be valid to supply electric energy by comparing a time at which the two power channels were coupled to.

Preferably, the receiving circuit comprises a resonant circuit and a rectifying circuit, the controller controls on and off states of switch transistors in the rectifying circuit in order to control the output power of the wireless power receiver while choosing the wireless power receiver for supplying electric energy, the rectifying circuit is a full-bridge rectifying circuit with at least two triodes, and the controller controls the switching operations of the triodes in order to control an output of the rectifying circuit by providing the control signal.

Preferably, the signal detection means provides a sampling electrical signal to the controller while detecting a power supply is coupled thereto, and the controller determines if there is any valid power energy after a comparison between the sampling electrical signal and a predefined threshold.

Preferably, the controller will switch to other available valid power channel after removing the prior used power channel during charging.

Preferably, the controller detects a battery level of the rechargeable battery in real time, and compares the battery level with a rated value, and stops charging when the battery level reaches the rated value.

On the third aspect, there is provided a battery pack for being charged in various manners, comprising:

a wireless power receiver comprising a receiving coil and a receiving circuit, wherein the receiving coil is configured to receive electromagnetic energy wirelessly from a wireless power transmitter, and the receiving circuit is configured to rectify and detect a receiving power;

a wired power receiver comprising a connector for receiving power energy from an external, wired power supply;

a signal detection means configured to detect the states of the wireless power transmitter and/or the external, wired power supply;

a controller configured to receive the states of the wireless power transmitter and/or the external wired power supply detected by the signal detection means and manage power channels in accordance with the states while the controlling unit is powered on;

at least one rechargeable battery configured to store and discharge power energy; and

a charging and discharging circuit, comprising a charging circuit configured to receive power energy from the wireless power receiver or the wired, power receiver and charge the rechargeable battery.

Preferably, the battery pack can discharge through a connector of the wired power receiver, and the controller can detect and control the discharging states of the rechargeable battery.

Preferably, the controller determines a power channel for supplying power energy in accordance with the connection sequence of the power channel according to the states of the power channels.

Preferably, the signal detection means provides an electrical sampling signal to the controller while a power supply is detected as being coupled thereto, the controller determines whether there is any valid input power by a comparison between the electrical sampling signal and a predefined threshold and, when both input powers are valid, the controller chooses one of them for supplying input power due to a predefined priority principal for charging, and switches to the other available valid power channel after removing the prior power channel during the charging process.

Preferably, the receiving circuit comprises a resonant circuit and a rectifying circuit is coupled electrically between the receiving coil and the charging and discharging circuit, the controller controls the switching operations of switch transistors in the rectifying circuit in order to control output power of the wireless power receiver.

Preferably, the rectifying circuit is a full-bridge rectifying circuit including at least two triodes and the controller controls switching operations of these triodes to control output power of the rectifying circuit by providing the control signals.

Preferably, the charging and discharging circuit further comprises a charging detection circuit configured to detect battery parameters of the rechargeable battery, the controller further comprises a battery monitoring module, and receives the battery parameters from the charging detection circuit through the battery monitoring module and controls output power of the wired power supply or the wireless power supply for providing proper power to the rechargeable battery.

Preferably, the charging detection circuit detects voltage states of the rechargeable battery, and then transfers them to the controller; the controller provides charging control signals to the wireless power transmitter through the wireless power receiver on the basis of the above states and the wireless power transmitter regulates an operation frequency and an output frequency of the transmit coil in accordance with the receiving charging control signals.

The charging system and charging method according to the disclosure uses wired and wireless power supply to charge a rechargeable battery, thus it greatly improves the convenience of charging.

On the other aspect, the battery pack according to the disclosure has a wired and a wireless charging function and is capable of charging a battery on wires or wirelessly. It solves the problems of the limitation of the power supply while it greatly improves the convenience of charging by providing more choices to users.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

FIG. 1 is a schematic circuit diagram of an exemplary charging system according to the description which follows;

FIG. 2a and FIG. 2b are schematic diagrams of exemplary rectifying circuits in two different implementation modes according to the description which follows;

FIG. 3 is a front view of an exemplary drilling tool with a battery pack according to the first embodiment of the present disclosure;

FIG. 4 is a charger for charging the battery pack of a drilling tool according to the description which follows;

FIG. 5 is a schematic circuit diagram of an exemplary battery pack according to the description which follows;

FIG. 6 is a front view of an exemplary drilling tool with a battery pack and a wireless power transmitter according to the description which follows;

FIG. 7 is a schematic circuit diagram of an exemplary charging system with an auto-adjusting function according to the description which follows;

FIG. 8 is a front view of an exemplary drilling tool with an internal battery and a charging device according to the description which follows;

FIG. 9 is a schematic circuit diagram of an exemplary adapter according to the description which follows;

FIG. 10 is a schematic circuit diagram of an exemplary charging system according to the description which follows; and

FIGS. 11a and 11b are logic control diagrams of an exemplary charging system according to the description which follows.

The drawings described herein are for illustrative purposes only of selected embodiments and not all possible implementations, and are not intended to limit the scope of the present disclosure. Corresponding reference numerals indicate corresponding parts throughout the several views of the drawings.

### DETAILED DESCRIPTION OF EMBODIMENTS OF THE INVENTION

The embodiments of the present disclosure will be described herein below in connection with the appended draws in detail.

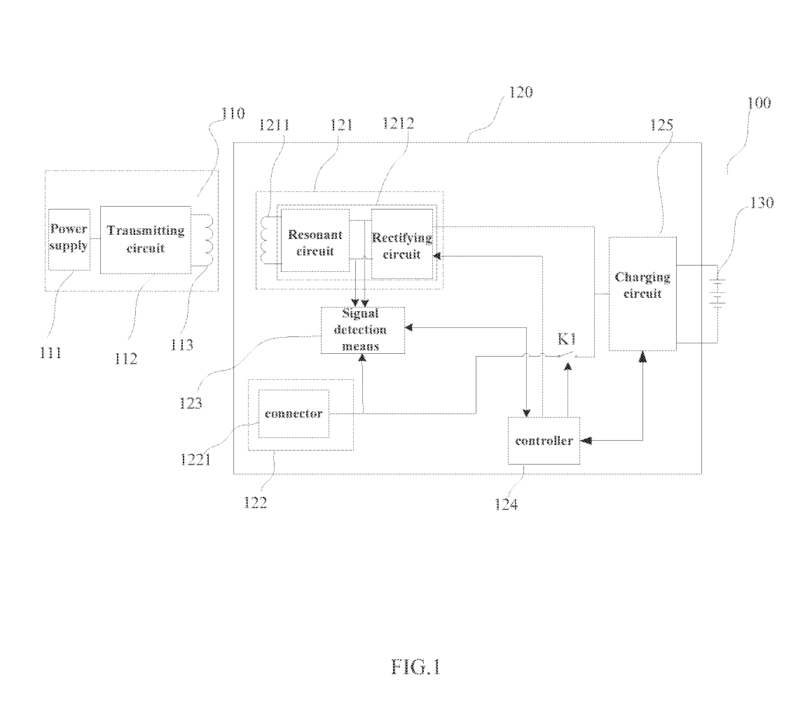

A schematic diagram of an exemplary circuit of a charging system 100 is shown in FIG. 1. Referring to FIGS. 1 to 3, one of ordinary skill in the art will readily recognize that the wireless power transmitter 110 comprises a power supply 111, a transmitting circuit 112 and a transmitting coil 113, wherein the transmitting coil 113 is electrically coupled to the transmitting circuit 112. The power supply herein generally is an AC power supply. The alternating current will convert into a direct current for charging other modules in the system through use of an AC-DC converter in the transmitting circuit when the AC power supply is coupled to the charging system. It is understood that the technology of wireless charging is well known in the art, which mainly includes an electromagnetic induction mode and/or a magnetic resonance mode. Electromagnetic induction mode is to employ the alternating current on the transmitting coil for wireless power transmission to change a magnetic field, and charge a rechargeable battery with an induced current provided by the adjacent receiving coil due to the variation of the magnetic field. In magnetic resonance mode, the magnetic field radiates around the transmitting coil on a specific frequency. When the receiving coil having the same frequency is close to the transmitting coil, it may receive the power energy to charge a rechargeable battery through the power channel which is generated because of resonance. The disclosure is not limited to any specific mode within the above ones, namely, the embodiment of the present disclosure may adopt any of them to charge the wireless power receiver wirelessly.

Referring to FIG. 1, a power receiver 120 comprises two power receivers one of which is a wireless power receiver 121 and the other of which is a wired power receiver 122, a signal detection means 123, a controller 124 and a charging circuit 125.

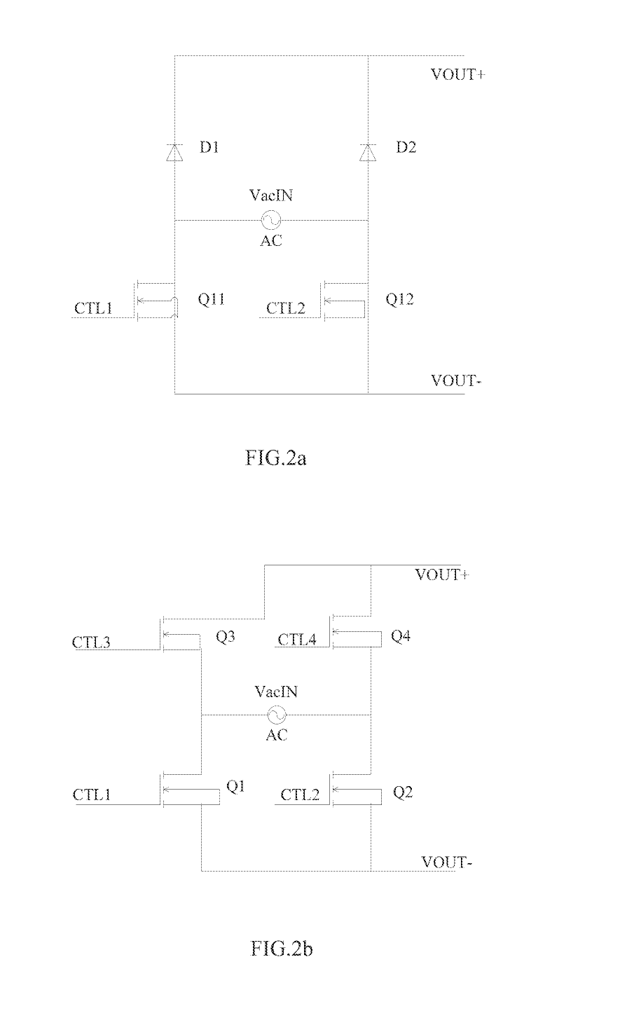

The wireless power receiver 121 comprises a receiving coil 1211 and a receiving circuit 1212. The receiving coil 1211 receives the electromagnetic energy wirelessly from the wireless power transmitter. The receiving circuit 1212 rectifies and detects a receiving voltage, and then provides a signal to the signal detection means 123. Specifically, the receiving circuit 1212 comprises a resonant circuit and a rectifying circuit. FIG. 2a and FIG. 2b respectively represent two different specific implementation modes of a rectifying circuit. Referring to FIG. 2a and FIG. 2b, the rectifying circuit having two diodes D1, D2 and two triodes Q11, Q12 shown in FIG. 2a is a full-bridge rectifying circuit which can be used to receive an alternating current. It controls the operation of the triodes Q11, Q12 to rectify an input voltage through the control signals CTL1 of Q11, and CTL2 of Q12 which are provided by the controller 124. There is no voltage output at the terminal Vout when Q11 and Q12 are both turned off. Referring to FIG. 2b, the rectifying circuit illustrated in FIG. 2b has four triodes Q1, Q2, Q3, and Q4 and is a full-bridge rectifying circuit which can be used to receive an alternating current. It controls the operation of the triodes Q1, Q4 and Q2, Q3 to rectify an input voltage through the control signals CTL1, CTL4, CTL2, CTL3 which are provided by the controller 124. There is no voltage output at the terminal Vout when Q1, Q2, Q3, Q4 are turned off.

The wireless power receiver 121 can provide power energy to a rechargeable battery by controlling the operations of the switches of the rectifying circuit by the controller 124, thus it will reduce heat losses and improve the charging efficiency. Comparing with the scheme of increasing additional transistor switches after rectifying a voltage, the scheme of controlling operation of the transistor switches in the rectifying circuit may decrease the elements in number, reduce the standby power consumption and improve the charging efficiency.

The receiving coil 1211 is used to receive electromagnetic energy from the wireless power transmitter, and provides a high-frequency, stable, sinusoidal wave to the rectifying circuit through the resonant circuit. The rectifying circuit is used to rectify the high-frequency sinusoidal wave, and convert it into direct current. The receiving circuit 1212 may further comprise a communication circuit which is configured to perform data communication with a rechargeable battery 130 and a wireless power transmitter 110. The communication data includes parameters representing wireless states for charging the battery, control commands, and other electric-specification parameters of battery.

The wired power receiver 122 comprises a connector 1221 which is used to couple a wired power supply. The connector 1221 can provide power energy to the rechargeable battery 130 through the controller 124 when it is coupled to an external power supply.

The controller 124 detects the states of the wired power supply or wireless power supply through a signal detection means 123. The signal detection means 123 will awake the controller 124 to perform state detection when a power supply is coupled thereto. The signal detection means 123 provides a sampling electrical signal to the controller 124, and the controller 124 will detect the states of the wired power supply and the wireless power supply. When wireless power energy from the wireless power supply first coupled is valid, the controller 124 controls the operation of the semiconductor switches in the rectifying circuit of the receiving circuit 1212 to choose a power channel. The controller 124 has a microcontroller MCU or other processor, as well as a storage unit in which the program code for controlling charging of the battery is stored. The controller 124 controls the switching states of the semiconductor switches in the rectifying circuit by providing driving signals by executing the program. When the switches are turned on, a charging circuit 125 is controlled to charge the rechargeable battery 130. The controller controls the operation of the switch K1 to output the power energy while choosing a wired power channel to supply electric energy.

Specifically, when a wireless power supply is coupled to the device the receiving coil 1211 will be coupled to the transmitting coil 113. More specifically, when an alternating current is applied to the transmitting coil 113, a magnetic field is generated by the transmitting coil 113 due to the variation of the current; and thus the receiving coil 1211 generates a current which is an alternating current. The alternating current is chopped into a sampling signal of direct current by a half-wave rectifier circuit formed by diodes and capacitors. The sampling signal is detected by the signal detection means 123. If the sampling signal reaches a predefined threshold which is a signal range, the controller 124 determines there is a valid power input; if it is below the threshold, the controller 124 determines there is not any valid power input; and if the sampling signal is larger than the threshold, an alert message will inform user and the signal detection means is turned off.

When a wired power supply is coupled, the controller 124 obtains a sampling signal for detection through a sampling resistor. If the voltage detected reaches the predefined threshold which is a voltage range, the controller 124 determines there is valid power input, if not, there is not any valid power input.

Preferably, the controller 124 controls the power channels to supply power energy in accordance with the coupling sequence of the power channels according to the states of the channels. If only one power energy channel is valid, the microcontroller MCU in the controller 124 or other processor will choose the one valid power energy channel for supplying electric energy. If both types of power energy channels are valid, the controller 124 will choose a power channel for supplying electric energy in accordance with a predefined priority principle of supplying energy, and switches to the other available valid power channel to supply power energy after removal of the prior power channel during the charging process. More particularly, the charging process herein includes: when the temperature of the battery is within the allowable range and the battery voltage is larger than the allowable pre-charging voltage, the charging circuit 125 controls voltage output to make the rechargeable battery 130 switch to a constant current charging mode; when the battery voltage is larger than or equal to the preset voltage, the charging circuit 125 controls voltage output to make the rechargeable battery 130 switch to a constant voltage charging mode, detects the temperature and current of the battery at the same time, and stops charging when the current of the battery is smaller than a preset current. The above charging process is well known to a skilled person in the art and, as such, it does not need to be described in greater detail herein.

It is noted that there are other ways to choose a wired or wireless power channel. For example, the controller 124 may detect the charging current of the rechargeable battery 130 to obtain the charging states of the rechargeable battery 130. When a wired power supply is used for charging and a wired power supply is coupled during charging, the controller 124 will shut off the power channel from the wireless power supply and use the power channel from the wired power supply in order to quickly charge the rechargeable battery 130. In another case, the controller detects the charging states of the wired and wireless power supplies or the coupling states of the wired and wireless power supplies and then choose a more preferred power supply to charge the rechargeable battery 130 after a comparison between them. Thus the battery is always charged by a power supply with a more preferred state.

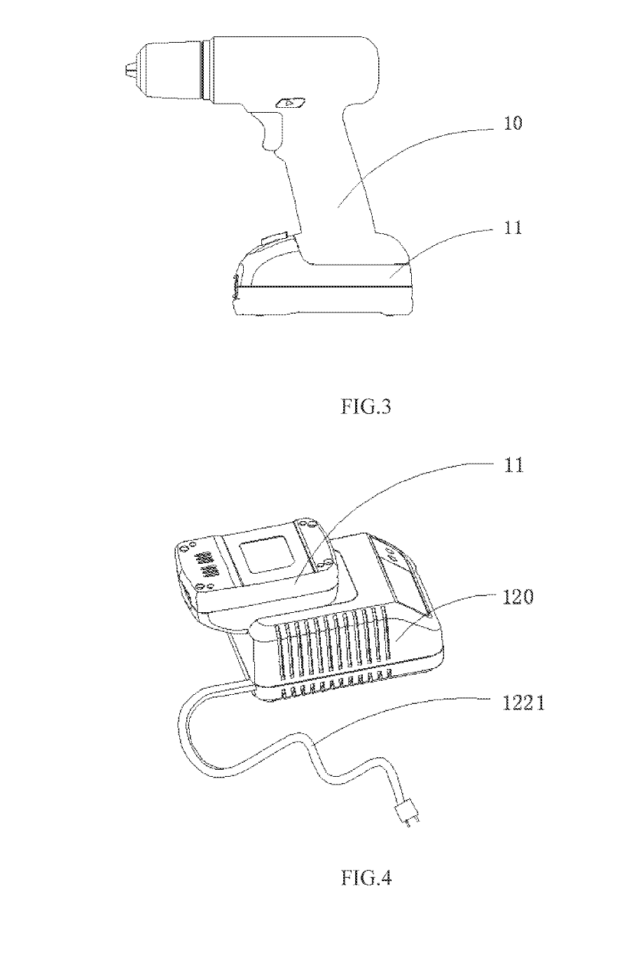

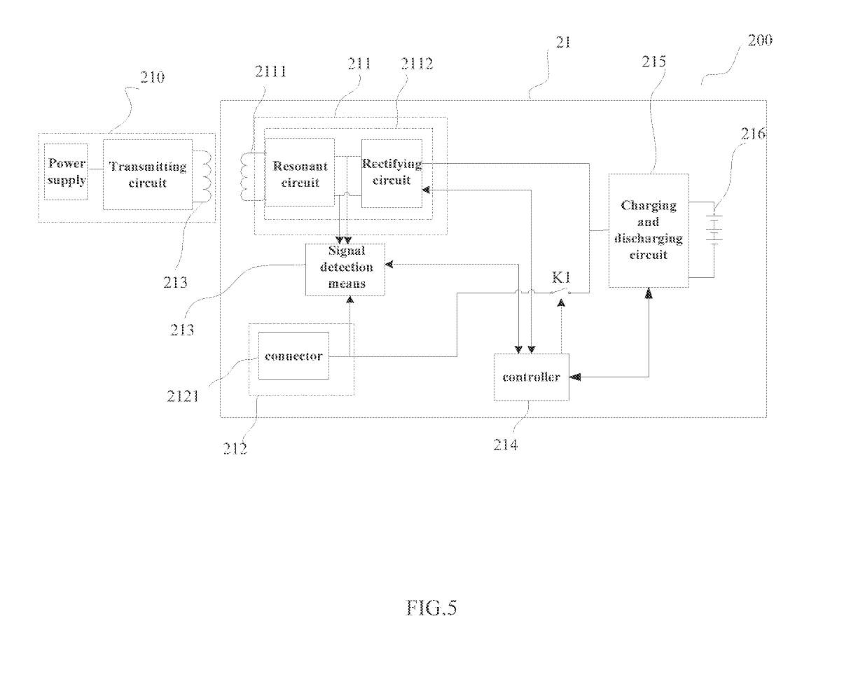

The rechargeable battery 130 can be used to supply power energy for an electrical tool, herein the rechargeable battery may be a nickel-cadmium battery, a nickel hydrogen battery or a lithium battery. Herein the electrical tool may be any one of drilling tools, hammering tools, sawing tools and garden tools, and also be any one of other kind of electrical tools which are well known by one skilled in the art. Referring the FIGS. 3 and 4, the electrical tool is a drilling tool. The battery pack 11 has a rechargeable battery 130 which is detachably attached to the drilling tool 10. A charger corresponding to the power receiver 120 comprises a wireless power receiver 121, a wired power receiver 122, a signal detection means 123, a controller 124 and a charging circuit 125. So the battery pack 11 attaching to the drilling tool can be charged through at least one of the wired or wireless power channels.

Referring the FIG. 5, a schematic diagram of the circuit of a battery pack 21 with a charging system 200 is shown. In this illustrated example, the circuits of power receiver 120 are integrated into battery pack 21. The battery pack 21 can be charged on wires or wirelessly. Particularly, referring the FIG. 5, 210 denotes a wireless power transmitter comprising a transmitting coil 213 which is the same as the wireless power transmitter 110 described in the first embodiment. The battery pack 21 comprises a wireless power receiver 211, a wired power receiver 212, a signal detection means 213, a controller 214 and a rechargeable battery 216. The wireless power receiver 211 has at least a receiving coil 2111 and a receiving circuit module 2112, and the wired power receiver comprises a connector 2121. The operational principles and logic control method for charging on wires or wirelessly which applied in the above battery pack 21 is the same as previously described. Moreover, the battery pack 21 may discharge through the connector 2121, and the controller 214 detects and controls the discharging states of the rechargeable battery 216.

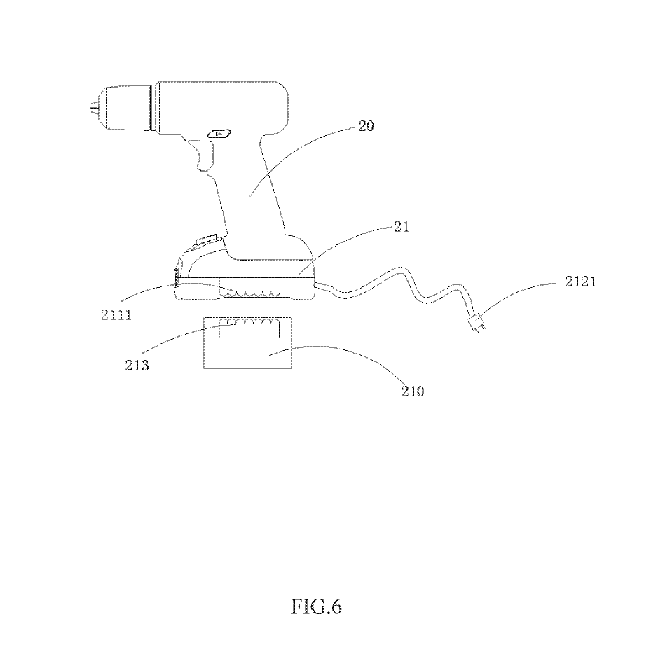

As shown in FIG. 6, an electrical tool comprising a battery pack 21 is shown. The battery pack 21 herein may be attached detachably to the electrical tool 20. It is understood that the battery pack 21 can also be built into the electrical tool 20.

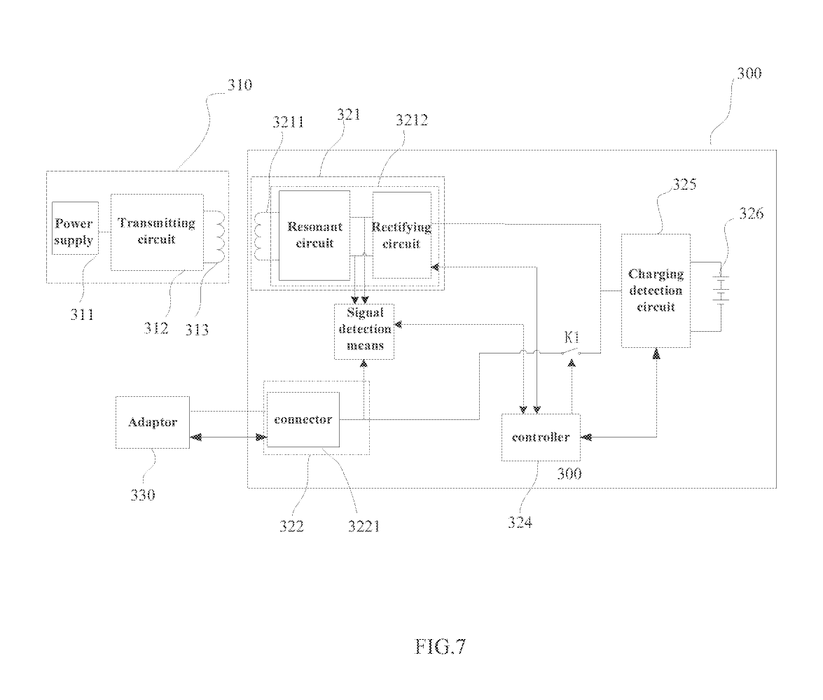

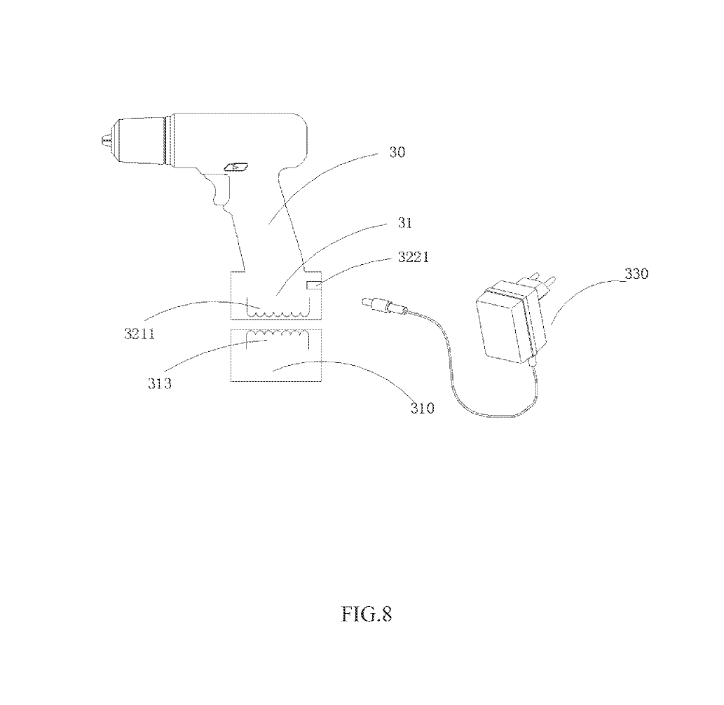

A schematic diagram of charging system 300 with auto-adjusting function is shown in FIG. 7. Particularly, the charging system 300 has a charging detection circuit 325 electrically coupled between the controller 324 and the rechargeable battery 326, a battery monitoring module and a charging and discharging control module. The controller 324 comprises a controller, and the battery monitoring module and the charging and discharging control module are integrated into the controller of the controller 324. Thus, during the charging process, the controller 324 will receive the battery parameters, such as voltage, current, temperature and so on, from the charging detection circuit 325 through the battery monitoring module and then provide the correct method for charging. The controller 324 controls the on and off states of the charging circuit through the MOSFET. It is understood that the battery monitoring module and the charging and discharging control module can also be located in the electrical tool 30. Specifically, the charging detection circuit 325 further comprises a voltage sampling circuit, a current sampling circuit, a temperature sampling circuit. During the charging process, the controller 324 obtains the present voltage, current and temperature from the rechargeable battery 326 through the sampling circuits respectively, and thus provides a charging signal to the wired and wireless power receiver for outputting a voltage or current desired by the rechargeable battery 326 in the end.

FIG. 8 illustrate that the charging system with auto-adjusting function applied in an electrical tool 30. Referring the FIG. 8 again, the electrical tool 30 comprises a battery pack 31 having a rechargeable battery 326 which is built into the electrical tool 30, a wireless power transmitter 310 and a wired adaptor 330, wherein a wireless power receiver 321 comprises a receiving coil 3211 and a receiving circuit 3212 receives wireless power energy from the wireless power transmitter 310 which comprises a power supply 311, a transmitting circuit 312, a transmitting coil 313 and a charging controller, and power energy and data signals are transmitted between the transmitting coil 313 and the receiving coil 3211. More specifically, the charging detection circuit 325 detects the voltage states of the rechargeable battery 326 and provides them to the controller 324. The controller 324 provides the charging control signals to the wireless power transmitter 310 on the basis of the states received. The charging controller in the wireless power transmitter 310 regulates the working frequency and output frequency of the transmitting coil 313 according to the control commands received to satisfy the charging requirements of the wireless power receiver 321. Compared with ordinary electrical products, the battery pack 31 used in electrical tools need a bigger power. So the charging system with the auto-adjusting function will make the wireless power transmitter 310 regulate the output frequency according to the frequency requirement of the wireless power receiver 321 and make the output frequency and voltage stable, which can meet user's needs to a greater extent.

The wired power receiver 322 may also receive power energy on wires from the adaptor 330. The adaptor 330 comprises the positive and negative terminals and the control terminal, and the connector 3221 of the wired power receiver 322 also comprises the positive and negative terminals and the control terminal. When a user choose a wired power supply, the adaptor 330 is coupled to the battery pack 31, of which the positive and negative terminals and the control terminal respectively contact with the same of the battery pack. During the charging process, the controller 324 obtains the present voltage, current and temperature from battery pack 31, and provides the charging signal to the control terminal of the adaptor through the matching circuit to control the charging process of the adaptor. When the temperature of the battery is within the allowable range and the battery voltage is larger than the allowable pre-charging voltage, the controller controls output voltage of the adaptor to make the battery pack 31 switch to a constant current charging mode; when the battery voltage is larger than the present value, the controller controls the output voltage of the adaptor to make the battery pack 31 switch to a constant voltage charging mode, and meanwhile detects the temperature and current of the battery pack 31, and stops charging when the current of the battery pack 31 is smaller than the present current.

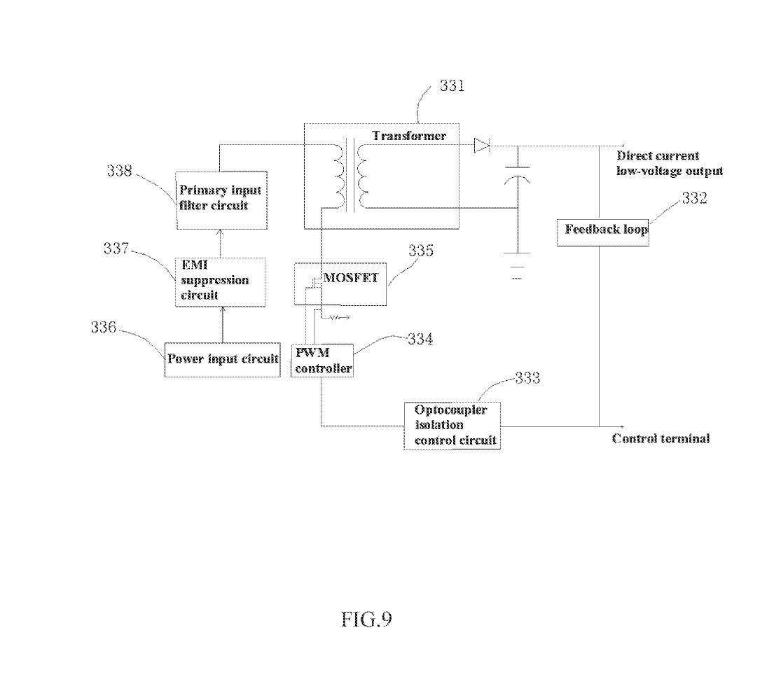

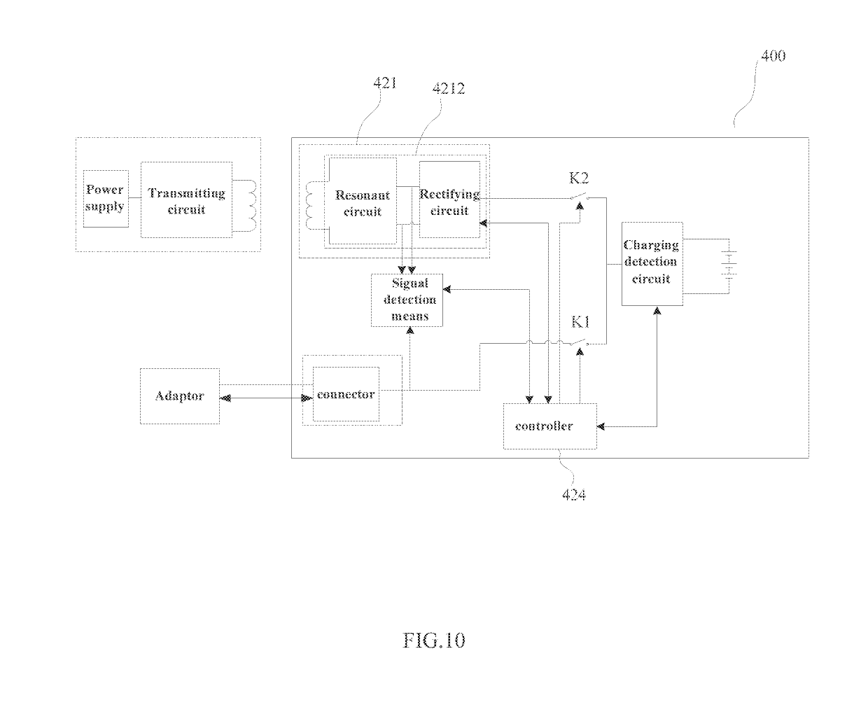

A schematic diagram of the circuit of the adaptor 330 is shown in FIG. 9. The adaptor 330 comprises a transformer 331, a feedback loop 332, an optocoupler isolation control circuit 333, PWM controller 334 and MOSFET 335. The alternating current from the power input circuit 336 transfers through the EMI suppression circuit 337, the primary input filter circuit 338, the transformer 331, and the secondary rectifier and filter circuit sequentially and converts into a high-voltage direct current. When the high-voltage direct current transfers through the circuit loop consisting of the feedback loop 332, the optical coupler isolation control circuit 333 and the PWM controller 334, the controller 324 provides a charging control signal through the control terminal of the adaptor 330 to PWM controller 334, and the PWM controller controls the operation of the MOSFET 335 according to the control signal to obtain the output voltage or current required by the battery pack 31. The power input circuit 335 consists of a fuse, a resistor of the negative temperature coefficient and a piezoresistor, and thus the input terminal of the power supply will not generate a short circuit current while abnormality occurs in the internal power supply. The power input circuit 335 also reduces the surge current while the power supply starts being turned on and absorbs the surge voltage from the input circuit to avoid the damage of the internal components in the power supply from an over-voltage condition. The rectifier and filter circuit in the adaptor 330 rectifies and filters out ripples of voltage smoothly, and provides relatively stable DC voltage for adaptor 330. It also filters out high-frequency switching noise, improves the conductive characteristics of the adaptor 330. Referring to FIG. 10, a schematic diagram of the wired/wireless charging and discharging system 400 is shown. In this illustrated example, an additional switch K2 is provided between the receiving circuit 4212 and the controller 424, thus the controller 424 can control the on and off states of the switch K2 to control the output power of the wireless power receiver 421 and does not need to control the operation of the switch transistors in the rectifying circuit of the receiving circuit 4212. It is understood that the output voltage of the wireless power receiver can also be controlled by increasing switch K2 in the other, formerly illustrated circuits.

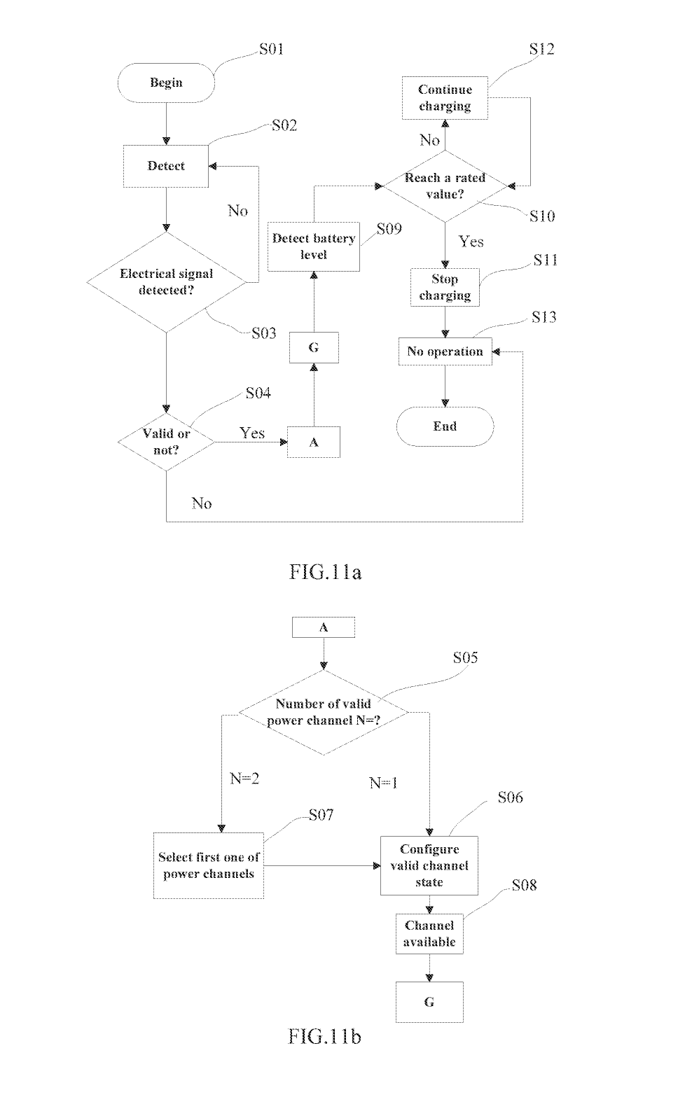

Reference will now be made in detail to the procedure of the controlling of power transmission in terms of the states of power channels according to the embodiment of the disclosure. A logical control diagram of the charging and discharging system according to the present disclosure is shown in FIG. 11a. Detailed description of the charging system will be set forth along with FIG. 11b.

Firstly, at step S01, a user determines which of wired or wireless power supply is coupled according to the operating condition. At step S02, the signal detection means detects the states of the power supply. At step S03, it is confirmed whether there is any electrical signal, and if there is no signal detected, the process returns to step S02, and if there is signal detected, the process goes to the determining step S04. At step S04, it is determined whether the received power energy is valid, specifically, it can be determined by identifying the various characteristic parameters representing the connection mode such as level, impedance, pulse string and so on. If the power energy is not valid, the process returns to step S13, and does not perform a charging operation. In the particular products, a user can be prompted that the power supply fails to be coupled and the charging operation will not continue by an indicator light or a voice reminder.

If the power energy is valid, the process goes to next step at which to select a power channel and charge the battery through it. Here, detailed description of selection of the power channel is made in connection with FIG. 11b. At step S04, it is determined whether the received power energy is valid. Specifically, it can be determined by judging whether the coupling is a rated configuration. If the determination is negative, the process goes to step S13 at which no operation is performed. If the determination is positive, the channel selection will be performed at the step A to G at which the controller determines which of the power channels of wired or wireless receiver is valid. At step S05, the number of valid power channels N are determined. If N is equal to one, the process goes to step S06; if N is equal to two, the process goes to step S07. At step S06, the one valid channel is configured to be valid for charging. At step S07, the power channel first coupled to the device is selected by comparing the time when the two power channels were coupled thereto, and then the process returns back to step S06 at which the channel selected is configured to be valid and used for charging. Meanwhile, the channel later coupled is not allowed to charge. However, when the power channel first coupled is removed, the other available valid power channel is configured to be valid to supply electric energy. When a valid power channel is selected, the process goes to S09, and the controller controls the on and off states of the switches for charging.

Specifically, the controller 124, 224, 324 controls the operations of the switches in the rectifying circuit for charging while using the wireless power receiver 121, 221, 321 for charging and the controller 424 controls the operations of the switch K2 to control the wireless power receiver 421 for charging. When the wired power channels are used for charging, the controller controls the switch K1 to control output power. When the power channels selected are used, the charging circuit charges the rechargeable battery in a charging mode.

Referring to FIG. 11b, Step A to step G represents a procedure in which to choose a valid power channel for charging. It may comprise step S09. At step S09, a control module in the controller or the charging circuit detects battery level of the rechargeable battery in real time. At step S10, it is determined whether the battery level reaches the rated value, if it reaches the value, the process goes to step S11 at which to stop charging, if it is not, the process goes to step S12 at which to continue charging. Moreover, the charging for the rechargeable battery will stop if the supply power is detached deliberately during the charging process. It is understood that some designs for protection of charging may be made according to the characteristics of battery and circuit, depending upon the practical requirements, such as over-temperature protection, over-current protection, over-voltage protection and so on.

Although some preferred embodiments are described as above, it is not used to limit the present disclosure. The ordinary skilled person in the art will understand that there are various modifications and changes within the doctrine and spirit of the present disclosure. The disclosure is intended to cover alternatives, modifications and equivalents that may be included within the spirit and scope of the invention as defined by the appended claims.

What is claimed is:

1. A charging system, comprising:
a wireless power transmitter configured to transmit electromagnetic energy;
a wireless power receiver comprising a receiving coil and a receiving circuit, wherein the receiving coil is configured to receive the electromagnetic energy wirelessly from the wireless power transmitter, and the receiving circuit is configured to rectify and detect a receiving power;
a wired power receiver comprising a connector for receiving power energy from an external, wired power supply;
a signal detection means configured to detect a state of the wireless power transmitter and/or the external wired power supply;
a controller configured to manage power channels in accordance with the state of the wireless power transmitter and/or the external wired power supply detected by signal detection means; and
a charging circuit configured to receive power energy from one of the wireless power receiver and wired power receiver and to charge a rechargeable battery.

2. The charging system according to claim 1, wherein the wireless power transmitter comprises a power supply, a transmitting circuit and a transmitting coil which are electrically coupled to each other.

3. The charging system according to claim 2, wherein power energy and data signals are transmitted between the transmitting coil of the wireless power transmitter and the receiving coil of the wireless power receiver.

4. The charging system according to claim 1, wherein the receiving circuit is electrically coupled between the receiving coil and the charging circuit and the receiving circuit comprises a resonant circuit and a rectifying circuit.

5. The charging system according to claim 1, further comprising an adapter for providing power energy through wires, wherein the adaptor is electrically coupled to the connector of the wired power receiver.

6. The charging system according to claim 1, wherein the charging circuit comprises a charging detection circuit for detecting voltage states of the rechargeable battery and providing the voltage states to the controller.

7. The charging system according to claim 6, wherein the controller comprises a battery monitoring module, and the controller is configured to obtain battery parameters from the charging detection circuit by using the battery monitoring module and provide a charging control signal on the basis of the battery parameters to the wireless power transmitter through the wireless power receiver, and the wireless power transmitter comprises a power supply controller configured to automatically regulate an operation frequency and an output power of the transmitting coil in accordance with the charging control signal.

8. A method for charging a rechargeable battery in a system in which a wireless power transmitter and/or an external, wired power supply is respectively coupled to a wireless power receiver or a wired power receiver, comprising:
detecting states of power channels provided by the wireless power transmitter and/or an external, wired power supply by a signal detection means;
determining whether each of the power channels is valid or not and determining a number of the valid channels by a controller; and
when the number of valid channels is determined to be one, using the one valid power channel for supplying electric energy and, when the number of valid channels is determined to be two, using a first one of the power channels having been coupled to for supplying electric energy wherein the first one of the power channels having been coupled to is determined by comparing a time when the two power channels were coupled to.

9. The charging method according to claim 8, wherein the receiving circuit comprises a resonant circuit and a rectifying circuit, the controller controls on and off states of switch transistors in the rectifying circuit in order to control the output power of the wireless power receiver while choosing the wireless power receiver for supplying electric energy; the rectifying circuit is a full-bridge rectifying circuit with at least two triodes, and the controller controls the switching operations of the triodes in order to control an output of the rectifying circuit by providing the control signal.

10. The charging method according to claim 8, wherein the signal detection means provides a sampling electrical signal to the controller while detecting a power supply is coupled thereto, and the controller determines if there is any valid power energy after a comparison between the sampling electrical signal and a predefined threshold.

11. The charging method according to claim 8, wherein the controller will switch to the other available valid power channel after a removal of the power channel that was being used during charging.

12. The charging method according to claim 8, wherein the controller detects a battery level of the rechargeable battery in real time, and compares the battery level with a rated value, and stops charging when the battery level reaches the rated value.

13. A battery pack, comprising:
a wireless power receiver comprising a receiving coil and a receiving circuit, wherein the receiving coil is configured to receive electromagnetic energy wirelessly from a wireless power transmitter, and the receiving circuit is configured to rectify and detect a receiving power.
a wired power receiver comprising a connector for receiving power energy from an external, wired power supply;
a signal detection means configured to detect a state of the wireless power transmitter and/or the external, wired power supply;
a controller configured to receive the state of the wireless power transmitter and/or the external, wired power supply detected by the signal detection means and manage power channels in accordance with the states while the controlling unit is powered on;
at least one rechargeable battery configured to store and discharge power energy; and
a charging and discharging circuit, comprising a charging circuit configured to receive power energy from the wireless power receiver or the wired power receiver and charge the rechargeable battery.

14. The battery pack according to claim 13, wherein the battery pack discharges through a connector of the wired power receiver and the controller detects and controls the discharging states of the rechargeable battery.

15. The battery pack according to claim 13, wherein the controller determines a power channel for supplying power energy in accordance with the connection sequence of the power channels according to the states of the power channels.

16. The battery pack according to claim 13, wherein the signal detection means provides an electrical sampling signal to the controller while detecting a power supply is coupled thereto, the controller determines whether there is any valid input power by a comparison between the electrical sampling signal and a predefined threshold and, when both input powers are determined to be valid, the controller chooses one of the valid power channels for supplying power as a function of a predefined priority principle for charging and switches to the other of the valid power channels after a removal of the power channel that was being used prior during the charging.

17. The battery pack according to claim 13, wherein the receiving circuit comprises a resonant circuit and a rectifying circuit is coupled electrically between the receiving coil and the charging and discharging circuit and the controller controls the switching operations of switch transistors in the rectifying circuit in order to control output power of the wireless power receiver.

18. The battery pack according to claim 17, wherein the rectifying circuit is a full-bridge rectifying circuit including at least two triodes and the controller controls switching operations of the at least two triodes to control output power of the rectifying circuit by providing the control signals.

19. The battery pack according to claim 13, wherein the charging and discharging circuit further comprises a charging detection circuit configured to detect battery parameters of the rechargeable battery, the controller further comprises a battery monitoring module and receives battery parameters from the charging detection circuit through the battery monitoring module and controls output power of the wired power supply or the wireless power supply for providing proper power to the rechargeable battery.

20. The battery pack according to claim 19, wherein the charging detection circuit detects voltage states of the rechargeable battery and then transfers them to the controller, the controller provides charging control signals to the wireless power transmitter through the wireless power receiver as a function of the detected voltage states, and the wireless power transmitter regulates an operation frequency and an output frequency of the transmit coil in accordance with the receiving charging control signals.
